(19) United States
(12) Patent Application Publication
(10) Pub. No.: US 2009/0043490 A1
(43) Pub. Date: Feb. 12, 2009

(54) LOCATION GUIDANCE APPARATUS AND METHOD OF PARKED VEHICLE

(75) Inventor: Jae-Hun JUNG, Yongin-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/188,006

(22) Filed: Aug. 7, 2008

(30) Foreign Application Priority Data
Aug. 8, 2007 (KR) 10-2007-0079825

(51) Int. Cl. G01C 21/00

(52) U.S. Cl. 701/201; 701/207; 701/213; 701/208

(57) ABSTRACT

A location guidance apparatus including a position detecting unit configured to detect a current position of the location guidance apparatus, an input unit configured to input at least one of a path guidance setting mode and path guidance providing mode, a storage unit configured to store position and movement information of the location guidance apparatus, and a control unit configured to store a first position of the location guidance apparatus and to determine a moving path from the first position to a second position of the location guidance apparatus when the path guidance setting mode is input, and to provide path guidance information including a reverse of the moving path including the second position to the first position when the path guidance providing mode is input.

### CROSS REFERENCE TO A RELATED APPLICATION

The present application is related to and claims priority to Korean patent application 10-2007-0079825, filed on Aug. 8, 2007, the entire contents of which are hereby incorporated by reference.

### BACKGROUND OF THE INVENTION

1. Field of the Invention

The present invention relates to a portable location guidance apparatus and corresponding method for providing guidance information on a previous path taken.

2. Description of the Related Art

Many public institutions, shopping centers, recreational facilities, etc. include large indoor and outdoor parking structures or garages to handle the numerous numbers of vehicles. However, because there are several hundred or even thousand of parking spots within a single parking structure, it is often very difficult for someone to find the location of their parked car, especially if the person is not readily familiar with the parking structure.

Thus, the user often tries to find their vehicle by pressing an alarm button on their vehicle keys. However, the user must be within several feet from where the vehicle is parked in order for the alarm to sound on their vehicle. The alarm on their vehicle also unnecessarily alerts security personnel at the parking structure as well as other vehicle owners.

Parking structures also use a numbering system to label individual parking spots. However, the user must first recognize the particular number and also remember the particular number for their parking spot. When the user parks the car for several hours, it is often very difficult to remember what the parking spot was when returning to the vehicle. Further, the assigned parking number generally does not sufficiently assist the user in determining what section or portion of the garage that the parking spot is located.

### SUMMARY OF THE INVENTION

Accordingly, one object of the present invention is to address the above-noted and other drawbacks.

Another object of the present invention is to provide a guidance portable apparatus and corresponding method that informs a user of the location of a parked vehicle without causing alarm to other people.

Another object of the present invention is to provide a guidance portable apparatus and corresponding method that guides a person to their parked vehicle.

To achieve these and other advantages and in accordance with the purpose of the present invention, as embodied and broadly described herein, the present invention provides in one aspect a location guidance apparatus including a position detecting unit configured to detect a current position of the location guidance apparatus, an input unit configured to input at least one of a path guidance setting mode and path guidance providing mode, a storage unit configured to store position and movement information of the location guidance apparatus, and a control unit configured to store a first position of the location guidance apparatus and to determine a moving path from the first position to a second position of the location guidance apparatus when the path guidance setting mode is input, and to provide path guidance information including a reverse of the moving path including the second position to the first position when the path guidance providing mode is input.

In another aspect, the present invention provides a location guidance method including detecting a current position of a location guidance apparatus, inputting at least one of a path guidance setting mode and a path guidance providing mode, storing a first position of the location guidance apparatus, determining a moving path from the first position to a second position of the location guidance apparatus when the path guidance setting mode is input, and providing path guidance information including a reverse of the moving path including the second position to the first position when the path guidance providing mode is input.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is an overview illustrating a location guidance apparatus according to a first embodiment of the present invention;

FIG. 2 is a flowchart illustrating a method of guiding a user to his or her parked vehicle using the location guidance apparatus illustrated in FIG. 1;

FIG. 3 is an overview illustrating a location guidance apparatus according to a second embodiment of the present invention;

FIG. 4 is a flowchart illustrating a method of guiding a user to his or her parked vehicle in a GPS satellite signal reception mode according to the second embodiment of the present invention;

FIG. 5 is a flowchart illustrating a method of guiding a user to his or her parked vehicle in a non-GPS satellite signal reception mode according to the second embodiment of the present invention;

FIGS. 6A and 6B are flowcharts illustrating a method of guiding a user to his or her parked vehicle when the location guidance apparatus is converted from the GPS satellite signal reception mode to the GPS satellite signal non-reception mode according to the second embodiment of the present invention;

FIG. 7 is an overview illustrating an example of a path along which the location guidance apparatus moves;

FIG. 8 is an overview illustrating an example of a current position of the location guidance apparatus being displayed according to an embodiment of the present invention;

FIG. 9A is an overview illustrating an example of the location guidance apparatus displaying path guidance information according to an embodiment of the present invention; and

FIG. 9B is an overview illustrating another example of the location guidance apparatus displaying path guidance information according to an embodiment of the present invention.

### DESCRIPTION OF THE INVENTION

Reference will now be made in detail to the preferred embodiments of the present invention, examples of which are illustrated in the accompanying drawings. Further, the following description assumes the location guidance apparatus is a portable device and detachably attached to a vehicle.

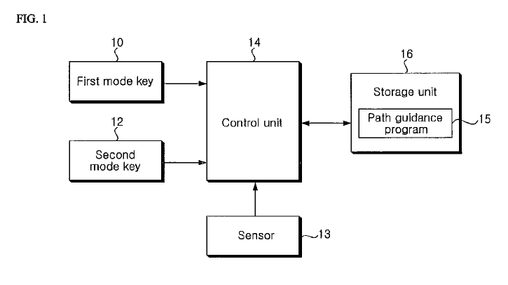

FIG. 1 is an overview illustrating a location guidance apparatus according to a first embodiment of the present invention. In this embodiment the location guidance is provided only using a sensor that provides position/direction information. As shown in FIG. 1, the apparatus includes a first mode key 10 and a second mode key 12. The first mode key 10 is a mode key for setting a path guidance, and when operated, the location of a vehicle is stored. Then, when the user moves, information on the user's movement is stored.

In addition, the second mode key 12 is a mode key for receiving path guidance information, and when operated, the stored movement information is extracted and information on the path guidance to the location of the vehicle is output. In addition, although the first and second mode keys 10 and 12 are separately configured in FIG. 1, the first and second mode keys 10 and 20 can be configured as one mode key whose function is changed each time the one mode key is operated.

As shown in FIG. 1, the apparatus also includes a sensor 13 for extracting the movement information in which the apparatus moves from the current position. That is, the sensor 13 extracts information on a direction (left/right/up/down/forward/backward) that the apparatus moves (or that the person carrying the apparatus moves). Thus, the sensor 13 is configured to detect a direction and distance, for example. Further, depending on the detection function, separate sensors such as a direction sensor and a position sensor may be provided, or the sensors may be configured as one sensor having a composite function. The sensor 13 may also include an altitude sensor that detects the current altitude of the apparatus.

The apparatus also includes a control unit 14 for controlling the apparatus to store a position of a vehicle when the first mode key 10 is operated, to receive movement information from the sensor 13 and to store the information in accordance with the sensed movement, and extract the stored movement information in the reverse direction to provide path guidance information from the current position to the location of the vehicle if the second mode key 20 is operated.

In addition, the apparatus includes a storage unit 16 for storing the movement information and a path guidance program 15 for extracting the stored movement information in the reverse direction such that the path guidance information can be provided to the user of the apparatus according to the operation of the second mode key 12. For example, if a path guidance command is input at the current position, the path guidance program 15 extracts a moving path from the current position to the location of the vehicle.

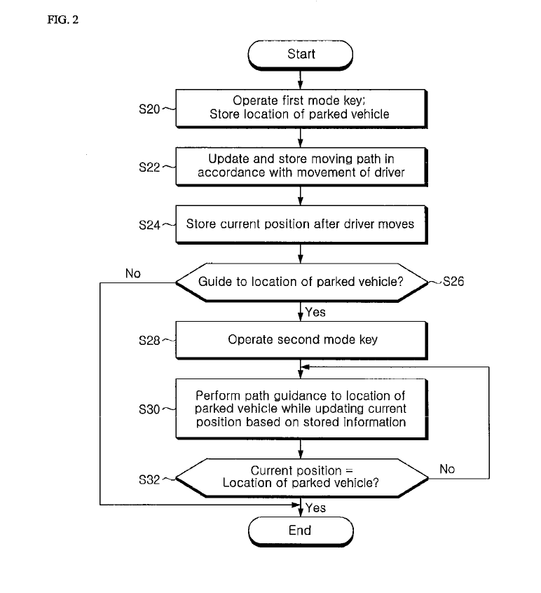

Next, a method of providing location guidance information of a parked vehicle according to the first embodiment will be described with reference to FIG. 2. In particular, FIG. 2 is a flowchart illustrating a method of providing guidance to the location of a parked vehicle using the location guidance apparatus according to the first embodiment of the present invention. FIG. 1 will also be referred to in this description.

As shown in FIG. 2, when the user or driver parks a vehicle and operates the first mode key 10 of the portable apparatus, the control unit 14 stores the location of the parked vehicle in the storage unit 16 (step S20). Thereafter, when the user starts to move in a certain direction while carrying the location guidance apparatus, the sensor 13 detects the moving direction from the location of the parked vehicle and the control unit 14 stores the sensed moving path of the apparatus (user) in the storage unit 16 (step S22).

Further, the control unit 14 continuously stores the moving path of the apparatus (user) until the second mode key 12 is operated (step S24). However, depending on the capacity of the storage unit 16 or user-preset conditions, the control unit 14 can only store the moving path for a certain time period, a certain distance, etc. However, it is preferable that the storage unit 16 has a sufficient memory capacity to store a moving path when the driver moves on foot from the parked vehicle, The user can also reselect the first mode key 10 to stop the control unit 14 from sensing and storing the movement information.

Then, when the driver wants to return from his or her current position to the location of the vehicle (Yes in step S26), the user can operate the second mode key 12 (step S28). The control unit 14 then recognizes that the user has operated the second mode key 12 and accesses information on the moving path stored in the storage unit 16 using the path guidance program 15. Then, the path guidance program 15 outputs path guidance information from the current position to the location of the parked vehicle in opposition to the path along which the user has moved (step S30).

Further, the path guidance program 15 continues to output the path information until the current position corresponds to the location of the parked vehicle (step S32). Further, the path guidance program 15 can output the path guidance information by displaying a guidance path on a screen and/or by outputting voice information on the direction back to the parked vehicle.

In addition, as discussed above, the user can selectively turn off the control unit 14 storing the path movement information from the parked vehicle to the current position of the user. For example, the user may walk from their parked vehicle to a main entrance at shopping mall, and be very familiar with the main entrance of the shopping mall. Thus, the user may want the control unit 14 to only store the moving path between the parked vehicle and the main entrance of the mall. Thus, the user can again select the first mode key 10 (or another key) at the entrance of the mall to command the control unit 14 to stop storing information on the user's moving path. Then, when the user wants to return to their parked vehicle after a day of shopping, for example, the user can simply return to the main entrance of the mall and then select the second mode key 12 to request the path information be displayed from the main entrance of the mall to the parked vehicle. Thus, the user can selectively determine how much of their moving path is to be stored based on their own personal preferences.

As described above, because the portable device stores information on the user's moving path and the moving path is then provided in the reverse direction, the user can easily locate their parked vehicle or find their direction to a previous location.

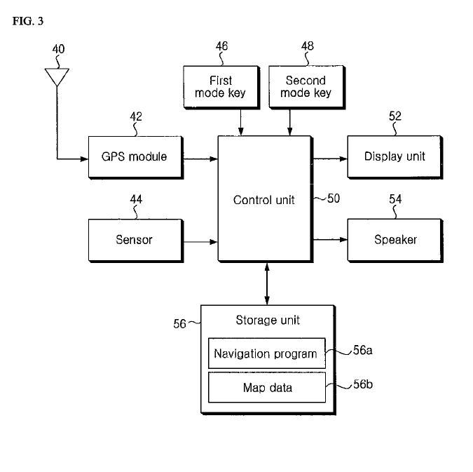

Next, FIG. 3 is an overview illustrating a location guidance apparatus according to a second embodiment of the present invention. In this embodiment, GPS satellite signals and sensor information are used in obtaining the moving path of the user.

As shown in FIG. 3, the apparatus includes a GPS antenna 40 for receiving GPS satellite signals from a plurality of GPS satellites. Further, the GPS satellite antenna 40 may be installed inside the portable apparatus or installed so as to protrude from the portable apparatus. The apparatus also includes a OPS module 42 for outputting information on the current position and time in the form of National Marine Electronics Association (NMEA) data, for example, based on the GPS satellite signals received through the GPS antenna 40.

In addition, the GPS module 42 also performs a function of determining a reception sensitivity of the GPS satellite signals received through the GPS antenna 40. If the reception sensitivity is extremely low, the GPS module 42 determines that the GPS satellite signals are not being properly received. Then, if the GPS satellite signals are not received, the NMEA data is not output. Further, the NMEA data refers to a standard protocol used in GPS transmitting and receiving operations.

In addition, the apparatus also includes a sensor 44 for extracting or sensing a moving direction and distance of the user (driver) holding the apparatus when the GPS module 42 determines that the GPS satellite signals cannot be sufficiently received through the GPS antenna 40. The sensor 44 operates in a similar manner as the sensor 13 in the first embodiment. That is, when the driver moves from the current parking location of the vehicle, the sensor 44 senses his or her moving path and this information is stored and later retrieved. Further, in the second embodiment, when the GPS satellite signals cannot be received, the sensor 44 is automatically activated so as to detect the moving path of the user.

Further, the apparatus also includes a first mode key 46 that is operated to set a path guidance mode when the driver parks a vehicle and moves from the vehicle, and a second mode key 48 that is operated to provide the driver with path guidance information from his or her current position to the parked vehicle. The first and second mode keys 46 and 48 may be provided as separate key buttons, or as a single key button whose function can be set to operate as the first mode key 46 in the initial operation and as the second mode key 48 in the next operation.

As shown in FIG. 3, the apparatus also includes a control unit 50 for controlling the apparatus to extract a current position and a moving path based on received GPS satellite signals or to extract the current position and the moving path using the sensor 44 depending on whether or not the GPS satellite signals are properly received. Then, when the user operates the first and second mode keys 46 and 48, the control unit 50 stores the moving path and provides path guidance information from the current position to the location of the parked vehicle based on the stored moving path.

Further, the control unit 50 can output the path guidance information using either a display unit 52 or a speaker 54, or both of them. For example, the control unit 50 can display the moving path on a screen of the display unit 52, and output guidance path voice commands or instructions via the speaker 54. Also, the apparatus includes a storage unit 56 for storing the obtained moving path of the user. As shown in FIG. 3, the storage unit 56 stores a navigation program 56A and map data 56B for displaying the current position by the navigation program 56A.

Next, a method of providing location guidance of a parked vehicle according to the second embodiment of the present invention having the aforementioned configuration will be described in detail in relation to a reception state of GPS satellite signals.

In Case of a GPS Satellite Signal Reception Mode

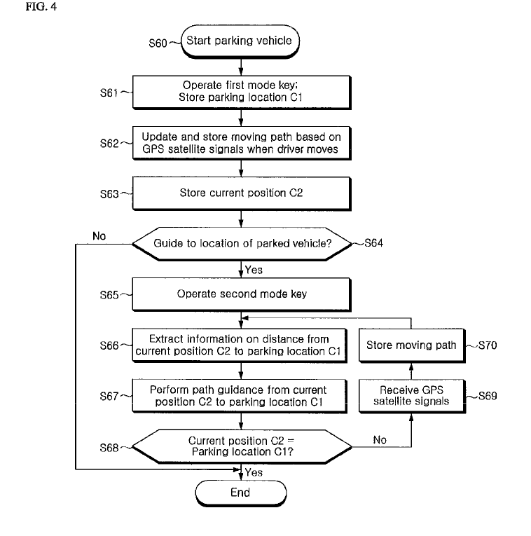

FIG. 4 is a flowchart illustrating a method of providing path guidance information to the location of a parked vehicle in a GPS satellite signal reception mode according to the second embodiment of the present invention. That is, FIG. 4 illustrates the situation in which GPS satellite signals can be received where a driver parks his or her vehicle and moves from the vehicle. FIG. 3 will also be referred to in this description.

As shown in FIG. 4, after the vehicle is parked at a certain place (step S60), the control unit 50 determines whether or not the user/driver has selected a path guidance setting mode. As discussed above, the user can set the path guidance setting mode by operating the first mode key 46. When the user operates or selects the first mode key 46, the control unit 50 stores a current parking position C1, i.e., the location where the vehicle is parked, in the storage unit 56 (step S61). Further, the location C1 is confirmed through the GPS satellite signals.

Then, while the user moves from the parking location C1, the control unit 50 stores a moving path along which the driver moves in the storage unit 56 based on the GPS satellite signals (step S62). In addition, because the GPS satellite signals are continuously received, the control unit 50 can periodically or continuously update the moving path. Then, when the user moves from the position C1 to a new position C2 away from the vehicle, the control unit 50 stores the current position C2 in the storage unit 56 (step S63). The position C2 is a current position of the user.

Then, when the user want to obtain path guidance from the current position C2 to the location C1 where the vehicle is parked (Yes in S64), the driver selects or operates the second mode key 48 (step S65). The control unit 50 then first extracts information on the distance from the current position C2 of the driver to the parking location C1 (step S66), and displays the path guidance information from the current position C2 to the parking location C2, e.g., the destination, on the display unit 52 (step S67). In addition, the control unit 50 can also output voice information related to the path guidance information through the speaker 54.

Further, the control unit 50 continues to provide the path guidance information until the current position of the user (C2) corresponds to the parking location C1 of the vehicle (step S68). That is, because the driver moves in the direction of the parked vehicle, the current position of the driver is continuously changed and eventually is the same as the position of the parked vehicle. Accordingly, whenever the current position of the driver is changed, the control unit 50 grasps the changed current position C2 of the driver, calculates the distance to the parking location C1, compares the current position with the parking location C1 (←C2), and informs the driver that the vehicle is parked at a position some distance ahead and some distance left or right, for example.

In addition, as shown in FIG. 4, if the current position C2 does not correspond to the parking location C1 of the vehicle (No in step S68), the control unit 50 continuously receives the GPS satellite signals and stores the moving path (steps S69 and S70), and repeatedly performs steps S66 and S67 until the current position C2 corresponds to the parking location C1 of the vehicle.

In Case of a GPS Satellite Signal Non-Reception Mode

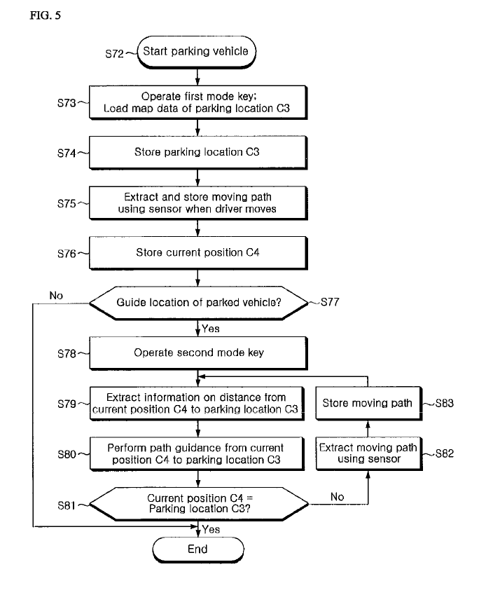

Next, FIG. 5 is a flowchart illustrating a method of providing guidance to the location of a parked vehicle in a GPS satellite signal non-reception mode according to the second embodiment of the present invention. FIG. 3 will also be referred to in this description.

In this embodiment, if the GPS satellite signals are not received, position information using the GPS satellite signals cannot be confirmed. Further, as discussed above, the control unit 50 can determine if the GPS satellite signals are sufficiently received by checking the reception sensitivity of the GPS module 42 for GPS satellite signals. That is, the control unit 50 is capable of determining that the GPS signals are not received at all and that the GPS satellite signals are received at a sensitivity that is much lower than a standard sensitivity and thus are not able to be properly received.

Accordingly, when the GPS signals can not be received, the sensor 44 is used to determine the position of the parked vehicle and the moving path of the user/driver. That is, when the user parks his or her vehicle at a location C3 and operates the first mode key 46, the control unit 50 loads map data corresponding to the current parking location C3 from the storage unit 56 and displays the map data on the display unit 52 (step S73). The map data 56b of the parking location C3 can be loaded using one or more pieces of information that can represent the parking location, such as an address, phone number, name, or the like. The user/driver can also view the location C3 to verify the provided information is accurate.

The control unit 50 then stores the parking location C3 in the storage unit 56 when the first mode key is operated (step S74). Next, as the user moves away from the parked vehicle toward his or her desired destination (e.g., entrance to a mall, library, etc.), the sensor 44 senses the user's motion and the control unit 50 uses the information to provide the moving path of the user. The moving path is also stored in the storage unit 56.

Specifically, as the user moves from the parking location C3, the sensor 44 detects a direction in which the user moves from the parking location C3 and stores the moving path in the storage unit 56 (step S75). That is, when the driver continuously moves in the forward/backward/left/right/up/down directions, the moving path of the driver is detected by the sensor 44 capable of detecting such moving directions, and the detected information is continuously stored in the storage unit 56. Further, the moving path stored in the storage unit 56 is movement information between the parking location C3 and the current position C4 of the driver. The current position C4 of the user is also stored in the storage unit 56 (step S76).

As discussed in the first embodiment, the user can then select the first mode key 46 at the position C4 such that his or her moving path is no longer stored. For example, if the position C4 is at an entrance to a mall or other building, the user may not need his or her movements that occur within the mall be stored. The user can thus selectively decide what movement paths are stored. Of course, the user can have his or her movement paths continuously stored even with the mall. The user can also set a time period at which the moving path is no longer stored (e.g., 15 minutes after first selecting the first mode key 46, etc.).

Next, when the user/driver wants to be provided with path guidance information from the current position C4 to the parking location C3 (Yes in S77), the user/driver operates the second mode key 48 (step S78). Then, the control unit 50 extracts information on the distance from the current position C4 to the parking location C3 based on the stored moving path information (step S79), provides the user/driver with path guidance information from the current position C4 to the parking location C3 (step S80).

In addition, as the driver continuously moves, the current position C4 is continuously changed based on the results of detection by the sensor 44. During this time, the control unit continuously checks to determine if the user/driver's current position C4 corresponds to the parking location C3 (step S81). When the positions C3 and C4 match (or are close enough to satisfy a preset condition) (Yes in step S81), the control unit 50 stops providing the path guidance information. Thus, the user can easily find out where their vehicle is parked using the provided guidance information. The control unit 50 can also output the path guidance information via the display unit 52 and/or via the speaker 54.

In addition, as shown in FIG. 5, if the current position C4 does not correspond to the parking location C3, the control unit 50 continues to extract the moving path using the sensor 44, to store the changing current position (steps S82 and S83), and to repeatedly perform steps S79 and S80.

Further, after the user selects the second mode key 48 in step S78, the control unit 50 continuously monitors whether the GPS satellite signals are received. If the GPS satellite signals are received, the path guidance information can provided after changing the current mode where the sensor 44 provides path guidance information to a mode where the path guidance information is provided based on the GPS satellite signals. That is, the control unit 50 switches between controlling the sensor 44 to provide the location information of the vehicle and movement information of the driver to using the GPS module 42.

In Case where a GPS Satellite Signal Reception Mode is Changed into a Non-Reception Mode

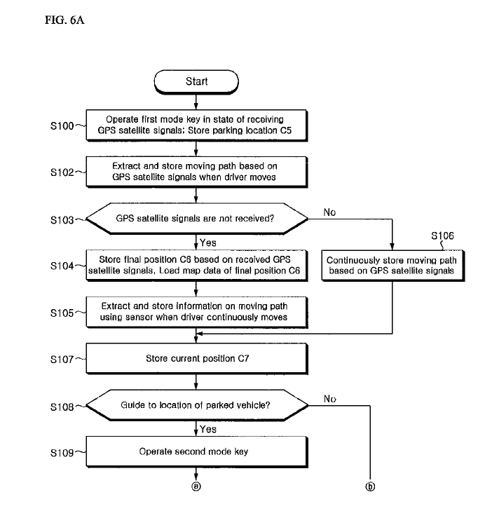

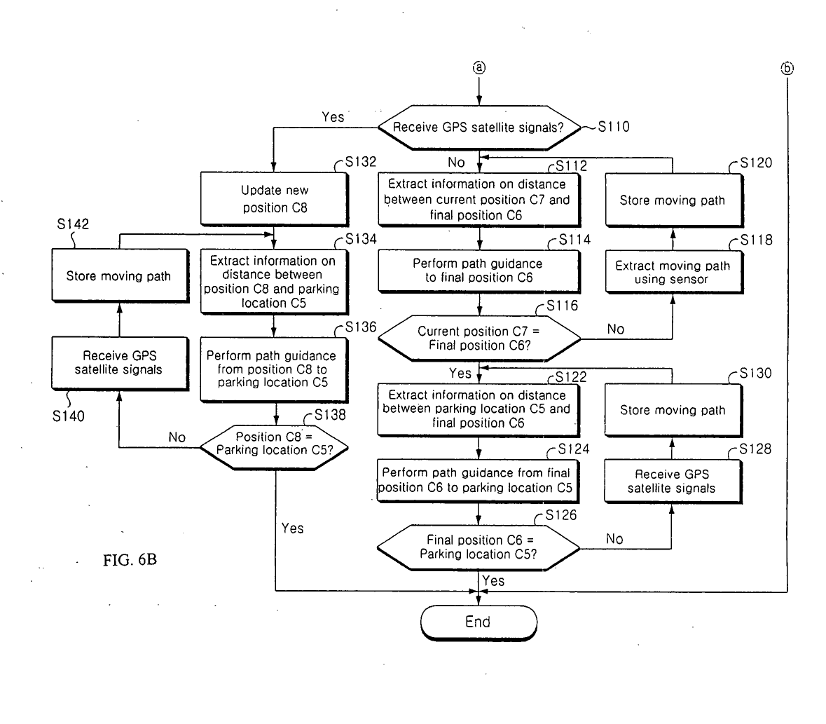

FIGS. 6A and 6B are flowcharts illustrating a method of providing guidance information about the location of a parked vehicle when the location guidance apparatus is converted from a GPS satellite signal reception mode to a GPS satellite signal non-reception mode according to the second embodiment of the present invention. FIG. 3 will also be referred to in this description.

As shown in FIG. 6A, after the user/driver parks the vehicle in a state where GPS satellite signals are received, and selects or operates the first mode key 46 to set a path guidance mode, the control unit 50 stores the current parking location C5 of the vehicle in the storage unit 56 (step S100). In addition, as the user moves away from the parked vehicle towards their desired destination, the control unit 50 continuously monitors the GPS module 42 and determines whether the GPS satellite signals are sufficiently received. When the GPS satellite signals are sufficiently received, the control unit extracts the moving path of the user based on the GPS satellite signals and stores the extracted moving path in the storage unit 56 (step S102).

Then, if the GPS satellite signals are not received (Yes in step S103), the control unit 50 stores a position C6 where the last GPS satellite signal is received and loads map data of the current position C6 (step S104). Then, the control unit 50 drives the sensor 40 and extracts the moving path of the user using the sensor 44 (step S105). On the other hand, if the GPS satellite signals are continuously received (No in step S103), the control unit 50 stores the moving path using the GPS satellite signals (step S106).

In addition, if the user stops moving while the moving path of the driver is extracted by the sensor or GPS satellite signals, the control unit 50 stores the stopped point as the current position C7 of the user (step S107). Then in step S108, the user either requests the path guidance information be provided to him or her (Yes in step S108) or continues moving toward their desired position (No in step S108).

If the user wants the path guidance information provided, the user/driver selects the second mode key 48 (S109). The process then flows to the flowchart shown in FIG. 6B to provide the user with path guidance information from his or her current position C7 to the position C5 where the vehicle is parked.

When the user operates the second mode key 48 in step S109, the control unit 50 determines whether the GPS satellite signals are received (step S110). If the control unit 50 determines the GPS satellite signals are not received (No in step S110), the control unit 50 preferably guides the user on a path from the current position C7 to the position where the moving path was started to be extracted by the sensor 44 based on the moving path information stored in the storage unit 56.

That is, the control unit 50 extracts information on the distance between the current position C7 and the final position C6 (step S112) and generates path guidance information from the current position C7 to the position C6 (step S114). In addition, the path guidance information from the current position C7 to the position C6 is provided until the current position C7 corresponds to the final position C6 (step S116). Further, the control unit 50 displays the path guidance information on the display unit 52 or outputs the path guidance information as voice information through the speaker 54. In addition, the process of continuously extracting/storing the moving path using the sensor 44 is performed until the current position C7 corresponds to the position C6 (steps S118 and S120), and steps S112 and S114 are repeated.

Then, when the user arrives at the position C6 (Yes in step S116), and GPS satellite signals start to be received from the position C6, the control unit 50 begins to extract information on the distance from the position C6 to the parking location C5 of the vehicle based on the GPS satellite signals (step S122). Further, the path guidance information is generated based on the extracted distance information and the GPS satellite signals (step S124), and the path guidance information is provided continuously until the position C6 corresponds to the location C5 of the vehicle (step S126). In the same manner, the processes of receiving the GPS satellite signals and storing the moving path are performed until the position C6 corresponds to the location C5 of the vehicle (steps S128 and S130), and steps S122 and S124 are repeated.

On the other hand, when the GPS satellite signals are received and the user operates the second mode key 48 to be provided with path guidance information at the current position C7, or when the driver does not move from the current position C7 to the position C6 but moves in another direction, for example, along a path where GPS satellite signals are received, the user is provided with the path guidance information using the GPS satellite signals from that position.

That is, if GPS satellite signals are received in step S110 or GPS satellite signals are received while the path guidance information is provided after step S112, the control unit 50 updates the current position of the user with a new position C8 in step S132 and extracts information on the distance from the new position C8 to the location C5 of the vehicle (step S134).

Then, the user is provided with path guidance information from the position C8 to the parking location C5 (step S136), which is performed until the position C8 corresponds to the parking location C5 (step S138). The correspondence between the position C8 and the parking location C5 can be determined by continuously receiving the GPS satellite signals and storing the moving path in the storage unit 56 (steps S140 and S142) and repeatedly performing steps S134 and S136.

Therefore, according to the above described embodiments, the location of a parked vehicle can be automatically guided by GPS satellite signals or a sensor for extracting a moving path of the user/driver from the parked vehicle.

Next, an example of the operation of the location guidance apparatus according to an embodiment of the present invention will be described.

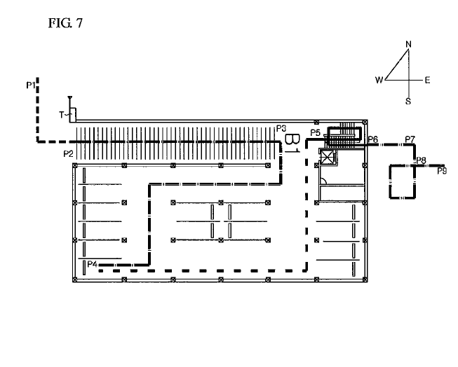

In more detail, FIG. 7 is an overview illustrating an example of a path along which the location guidance apparatus moves. In FIG. 7, it is assumed that the location guidance apparatus is with a user in a vehicle that has entered a parking structure. That is, the vehicle first arrives at a first underground entrance P3 of the parking structure from an external point P1 via the parking structure entrance P2, and moves to a certain parking location P4.

Then, the user gets out of the vehicle and walks to the stair entrance P5 of the parking structure while possessing the location guidance apparatus and arrives at the exit P6 of the parking structure on the ground level using the stairs. Then, the user moves (walks in this example) along the points P7, P8 and P9 at the outside of the parking structure.

Therefore, as the vehicle enters the parking structure from the external point P1 and passes through the entrance P2, the location guidance apparatus receives and stores detailed information on the parking place transmitted from a terminal T located at the parking structure. That is, the terminal T is for transmitting detailed information on the parking place. Further, the detailed information on the parking place can include map data.

However, when the user drives through the parking structure, it is probably difficult for the location guidance apparatus to receive GPS satellite signals (especially when the parking structure is underground as in this example). If the parking structure was an upper level open parking structure, the location guidance apparatus could still receive the GPS satellite signals. As discussed above, the control unit of the apparatus monitors and determines whether or not the location guidance apparatus can sufficiently receive the GPS satellite signals.

In the example shown in FIG. 7, when the location guidance apparatus can no longer receive the GPS satellite signals (e.g., when less than four GPS satellite signals are received and thus a position cannot be calculated), the location guidance apparatus calculates the current position using the sensor unit. That is, and as discussed above, the sensor unit includes a sensor for detecting a moving direction such as a gyro-sensor and a sensor capable of calculating an altitude such as an altitude sensor. The sensor can then determine or calculate the position of the location guidance apparatus including a floor number within the building, for example.

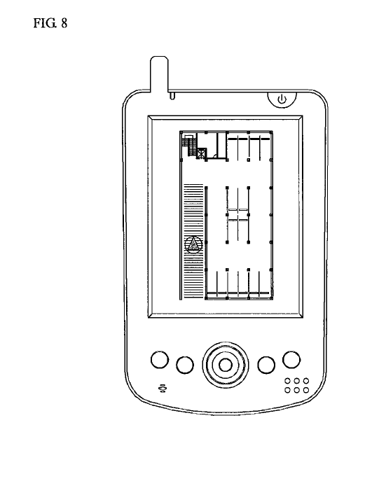

Next, FIG. 8 is an overview of a display screen of the location guidance apparatus as the vehicle passes through the point P2. As shown in FIG. 8, based on the detailed information on the parking structure, the current position of the location guidance apparatus is displayed. That is, the current location of the vehicle including the location guidance apparatus is displayed as an arrow in the example shown in FIG. 8. Other indicators may also be used to illustrate to the user where the vehicle is currently located within the parking structure.

In this example, it is assumed the user has the location guidance apparatus on, but has not yet selected the path guidance mode (e.g., by selecting the first mode key). The user then selects the path guidance mode after the user parks his or her vehicle at the parking location P4. The path guidance mode can be set by the user selecting the first mode key and can also be automatically set or executed when the control unit detects that user has detached the location guidance apparatus from its cradle. Then, when the path guidance mode is set, the location guidance apparatus stores a moving path of the user in the storage unit.

That is, in the example shown in FIG. 7, the location guidance apparatus stores the moving path of the user from the point P4 to the point P9. In addition, when the location guidance apparatus can not sufficiently receive COPS signals (e.g., between points P4 and P5), the location guidance apparatus automatically switches to using the sensor unit to detect the current position of the apparatus and to provide a moving path of the apparatus. Further, in one embodiment, the sensor unit includes an altitude sensor and thus can determine the user going up the staircase between point P5 to the point P6.

Then, when the user wants to return to his or her parked vehicle, the user can select the second mode key to enter the path guidance providing mode. The control unit then calculates the moving path of the user in a reverse direction using the moving path and position information stored in the storage unit. The control unit then display and/or outputs voice information informing the user of the path back to their vehicle.

Further, the reverse path to the parked vehicle may be calculated and displayed in increments between each points (e.g., a first path from P9 to P8, a second path from P8 to P7, etc.) or may be displayed in full from the point P9 to the point P4 where the vehicle is parked. The path guidance information can also be displayed so the shortest route to the parked vehicle is displayed. For example, the path guidance information can display a path from point P9 to point P7 to bypass the point P8 or display a path from point P9 to point P6 to bypass the points P7 and P8. In addition, the path guidance apparatus continues to update the display as the user moves along the path back to his or her car. The user can then disable the path guidance operations by placing the path guidance apparatus in its cradle, turning off the apparatus, reselecting the second mode key, etc.

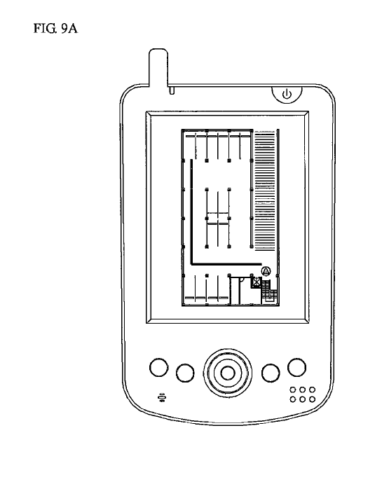

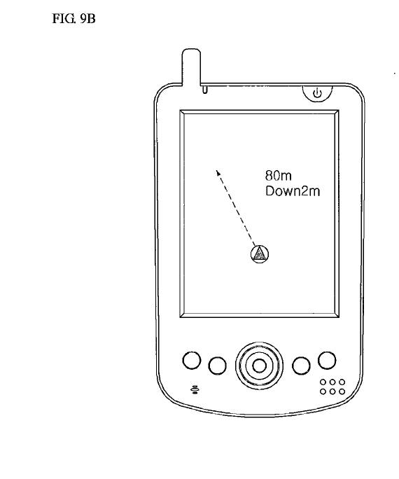

FIGS. 9A and 9B are overview illustrating another example of the path guidance apparatus displaying path guidance information. In this example, and as shown in FIG. 9A, the path guidance apparatus displays a particular route to a preferred or particular parking spot. That is, as the user enters the parking structure, the path guidance apparatus displays the shortest route, a route with open parking spots, etc. on the display screen. FIG. 9B illustrates another example of the location guidance apparatus displaying a minimized amount of information about the direction and distance from the current position to the first position (the parking location), and may include information such as the floor number, distance, direction, etc.

Further, the path guidance information displayed on the path guidance apparatus can be minimized when the apparatus can only receive a minimal amount of information. When more detailed information is available, the path guidance apparatus can display the more detailed information to the user.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A location guidance apparatus, comprising:
a position detecting unit configured to detect a current position of the location guidance apparatus;
an input unit configured to input at least one of a path guidance setting mode and path guidance providing mode;
a storage unit configured to store position and movement information of the location guidance apparatus; and
a control unit configured to store a first position of the location guidance apparatus and to determine a moving path from the first position to a second position of the location guidance apparatus when the path guidance setting mode is input, and to provide path guidance information including a reverse of the moving path including the second position to the first position when the path guidance providing mode is input.

2. The apparatus of claim 1, wherein the position detecting unit comprises at least one of a Global Positioning System (GPS) reception unit configured to receive satellite navigation signals including position information corresponding to the current position of the location guidance apparatus, and a sensing unit configured to sense the current position of the location guidance apparatus.

3. The apparatus of claim 2, wherein the control unit is further configured to determine when the GPS reception unit does not at all receive the GPS signals or does not receive the GPS signals at a specified reception sensitivity, and when the control unit does not does not at all receive the GPS signals or does not receive the GPS signals at the specified reception sensitivity, the control unit is further configured to exclusively use the sensor unit to determine the current location of the location guidance apparatus.

4. The apparatus of claim 1, wherein the location guidance apparatus is configured to be detachably installed into vehicle.

5. The apparatus of claim 4, wherein the control unit is further configured to control the input unit to automatically input the path guidance mode when the location guidance apparatus is removed from a corresponding cradle in the vehicle and to automatically stop the path guidance providing mode when the location guidance apparatus is reattached to the corresponding cradle in the vehicle.

6. The apparatus of claim 1, wherein the control unit is further configured to stop providing the path guidance information when the location guidance apparatus returns to within a predetermined position from the first position.

7. The apparatus of claim 1, wherein the input unit includes a first button configured in input the path guidance mode and a second button configured to input the path guidance providing mode.

8. The apparatus of claim 1, wherein the path guidance information includes at least one of a direction, a distance, map information, and an altitude change from the second position to the first position.

9. The apparatus of claim 8, wherein the map information data includes a layout of each floor of an indoor parking structure.

10. The apparatus of claim 9, wherein the indoor parking structure includes a transmitting terminal that transmits the map information data to the location guidance apparatus.

11. The apparatus of claim 1, further comprising:
a display unit configured to display at least one of the path guidance information and the current position of the location guidance apparatus; and
a voice guidance unit configured to provide the path guidance information and the current position of the location guidance apparatus using voice information.

12. A location guidance method, comprising:
detecting a current position of a location guidance apparatus;
inputting at least one of a path guidance setting mode and a path guidance providing mode;
storing a first position of the location guidance apparatus;
determining a moving path from the first position to a second position of the location guidance apparatus when the path guidance setting mode is input; and
providing path guidance information including a reverse of the moving path including the second position to the first position when the path guidance providing mode is input.

13. The method of claim 12, wherein the detecting step uses at least one of a Global Positioning System (GPS) reception unit configured to receive satellite navigation signals including position information corresponding to the current position of the location guidance apparatus, and a sensing unit configured to sense the current position of the location guidance apparatus.

14. The method of claim 13, further comprising:
determining when the GPS reception unit does not at all receive the GPS signals or does not receive the GPS signals at a specified reception sensitivity, and when the control unit does not does not at all receive the GPS signals or does not receive the GPS signals at the specified reception sensitivity, the detecting step exclusively uses the sensor unit to determine the current location of the location guidance apparatus.

15. The method of claim 12, wherein the location guidance apparatus is configured to be detachably installed into vehicle.

16. The method of claim 15, further comprising:
automatically inputting the path guidance mode when the location guidance apparatus is removed from a corresponding cradle in the vehicle and automatically stopping the path guidance providing mode when the location guidance apparatus is reattached to the corresponding cradle in the vehicle.

17. The method of claim 12, further comprising:
stopping the providing of the path guidance information when the location guidance apparatus returns to within a predetermined position from the first position.

18. The method of claim 12, wherein the path guidance information includes at least one of a direction, a distance, map information, and an altitude change from the second position to the first position.

19. The method of claim 18, wherein the map information data includes a layout of each floor of an indoor parking structure.

20. The method of claim 19, further comprising:
transmitting the map information data to the location guidance apparatus via a transmitting terminal in the indoor parking structure.

21. The method of claim 12, further comprising:
displaying at least one of the path guidance information and the current position of the location guidance apparatus; and
providing the path guidance information and the current position of the location guidance apparatus using voice information.
